(19) United States
(12) Patent Application Publication
(10) Pub. No.: US 2013/0155742 A1
(43) Pub. Date: Jun. 20, 2013

(54) MICRO-POWER RECTIFIER AND METHOD THEREOF

(71) Applicants: Ming-Wei Lee, Taichung City (TW); Gao-Ching Lin, Taichung City (TW)

(72) Inventors: Ming-Wei Lee, Taichung City (TW); Gao-Ching Lin, Taichung City (TW)

(73) Assignee: INDUSTRIAL TECHNOLOGY RESEARCH INSTITUTE, Hsinchu (TW)

(21) Appl. No.: 13/411,648

(22) Filed: Mar. 5, 2012

(30) Foreign Application Priority Data
Dec. 16, 2011 (TW) 100146919

(51) Int. Cl. H02M 7/06

(52) U.S. Cl. 363/126

(57) ABSTRACT

A micro-power rectifier including a plurality of charge pumps and a method of the micro-power rectifier are provided. The charge pumps respectively include an input capacitor, an output capacitor, a first diode and a second diode. Wherein, at least one of reference voltages of the output capacitors is greater than 0V, and other reference voltages of the output capacitors is/are a ground voltage. Therefore, the efficiency and the output voltage of the rectifier can be increased.

### CROSS-REFERENCE TO RELATED APPLICATION

This application claims the priority benefit of Taiwan application serial no. 100146919, filed on Dec. 16, 2011. The entirety of the above-mentioned patent application is hereby incorporated by reference herein and made a part of this specification.

### BACKGROUND OF THE DISCLOSURE

1. Field of the Disclosure

The disclosure relates to a rectifier. Particularly, the disclosure relates to a micro-power rectifier and a method thereof.

2. Description of Related Art

A rectifier can convert an alternating current (AC) signal into a direct current (DC) voltage or current. An energy harvesting system, a wireless energy transmission system and a radio frequency-identification (RFID) system and other systems all require the rectifier. For example, in the wireless energy transmission system or the RFID system, a system receiving end thereof requires a rectifier to convert an radio frequency (RF) signal (an AC signal) received by an antenna into DC energy. Since the RF signal attenuates along with a propagation distance in the air, the signal received by the rectifier is generally an AC signal of a micro-power level. On the other hand, in an existing energy harvesting system, regardless of an energy harvesting technique in allusion to RF energy or vibration energy, the rectifier used for converting the AC signal into the DC signal is required. Since the RF energy in the environment or the energy generated by vibration is very weak, the rectifier required by the energy harvesting system is required to convert the weak AC signal of a microwatt level into a DC voltage/current output.

### SUMMARY

The disclosure is directed to a micro-power rectifier and a method thereof, by which a direct current (DC) output voltage of the rectifier is increased and AC-DC conversion efficiency thereof is improved.

The disclosure provides a micro-power rectifier including a signal input terminal, a signal output terminal and a plurality of charge pump units. Wherein, each of the charge pump units respectively includes an input capacitor, an output capacitor, a first diode and a second diode. A first end of the input capacitor is coupled to the signal input terminal. A cathode of the first diode is coupled to a second end of the input capacitor. An anode of the first diode is coupled to a first reference voltage if the first diode belongs in the first charge pump unit (CP_1). The anode of the first diode is coupled to an output terminal of a pre-stage charge pump unit of the charge pump units if the first diode belongs in the other charge pump unit (CP_i), wherein i is an integer greater than 1. An anode of the second diode is coupled to the second end of the input capacitor. A cathode of the second diode serves as an output terminal of the charge pump unit. A first end of the output capacitor is coupled to the cathode of the second diode. A second end of the output capacitor is coupled to a second reference voltage. At least one of the first reference voltage and the second reference voltages is greater than 0V.

The disclosure provides a method of a micro-power rectifier. The micro-power rectifier is as that described above, and the method includes following steps. The signal input terminal receives an input voltage. A first reference voltage is provided to the anode of the first diode of the first charge pump unit (CP_1). A plurality of second reference voltages are provided to the second ends of the output capacitors of the charge pump units. At least one of the first reference voltage and the second reference voltages is increased to be greater than 0V.

According to the above descriptions, the disclosure provides a micro-power rectifier, which is composed of multistage charge pump units, so that the micro-power rectifier can gain an output voltage level. Moreover, a bias voltage greater than 0V is provided to at least one of the multistage charge pump units, so as to improve AC-DC conversion efficiency of the micro-power rectifier.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a micro-power rectifier according to an embodiment of the disclosure.

FIG. 2 is a circuit schematic diagram of a micro-power rectifier according to an embodiment of the disclosure.

FIG. 3 is an exemplary circuit schematic diagram of the rectifier of FIG. 2 in case of N=3.

FIG. 4 is an exemplary circuit schematic diagram of the rectifier of FIG. 3.

FIG. 5 is another exemplary circuit schematic diagram of the rectifier of FIG. 3.

FIG. 6 is another exemplary circuit schematic diagram of the rectifier of FIG. 3.

FIG. 7 is another exemplary circuit schematic diagram of the rectifier of FIG. 3.

FIG. 8 is another exemplary circuit schematic diagram of the rectifier of FIG. 3.

FIG. 9 is a circuit schematic diagram of a micro-power rectifier according to another embodiment of the disclosure.

FIG. 10 is a circuit schematic diagram of a micro-power rectifier according to still another embodiment of the disclosure.

FIG. 11 is a circuit schematic diagram of a micro-power rectifier according to still another embodiment of the disclosure.

FIG. 12 is a measurement diagram of conversion efficiency of a rectifier with a CMOS process and 7-stage charge pump units.

FIG. 13 is a measurement diagram of a DC output voltage of a rectifier with the CMOS process and 7-stage charge pump units.

### DETAILED DESCRIPTION OF DISCLOSED EMBODIMENTS

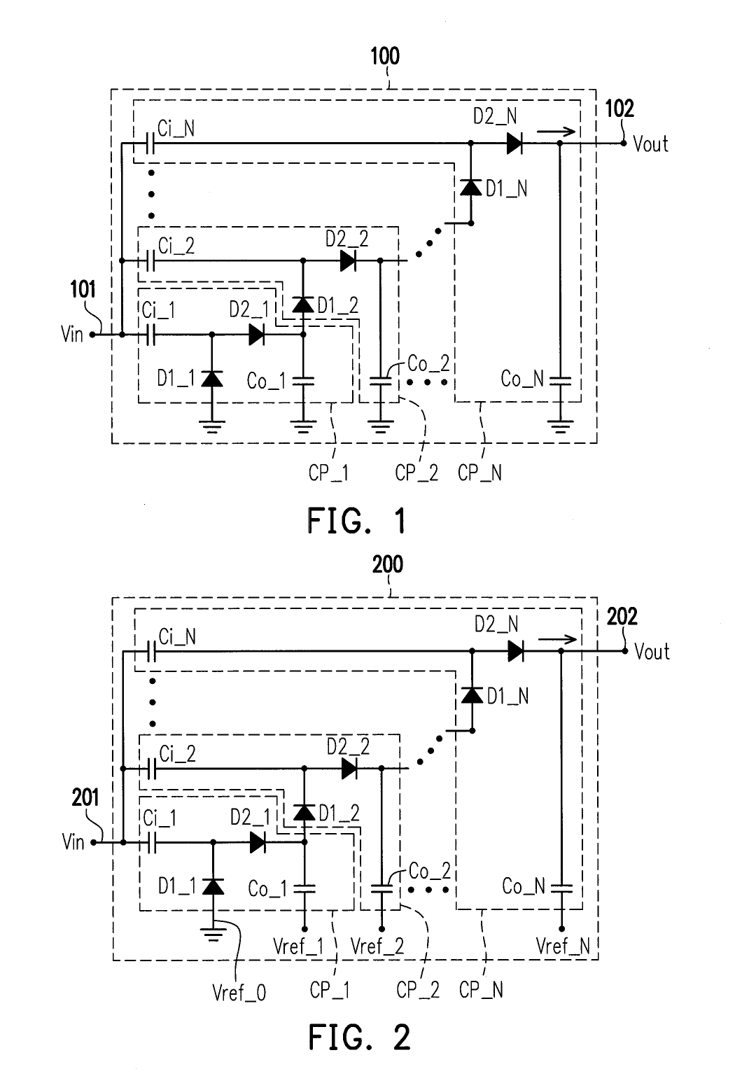

FIG. 1 is a schematic diagram of a micro-power rectifier 100 according to an embodiment of the disclosure. The micro-power rectifier 100 includes a signal input terminal 101, a signal output terminal 102 and N charge pump units CP_1, CP_2, . . . , CP_N, where N is an integer greater than 1, and i is defined as an integer greater than 1 and smaller than or equal to N.

Referring to FIG. 1, the first charge pump unit unit CP_1 includes an input capacitor Ci_1, an output capacitor Co_1, a first diode D1_1 and a second diode D2_1. A first end of the input capacitor Ci_1 is coupled to the signal input terminal 101 for receiving an alternating current (AC) input voltage Vin. A cathode of the first diode D1_1 is coupled to a second end of the input capacitor Ci_1. An anode of the first diode D1_1 is coupled to a first reference voltage (e.g. the ground voltage). An anode of the second diode D2_1 is coupled to the second end of the input capacitor Ci_1. A cathode of the second diode D2_1 serves as an output terminal of the first charge pump unit CP_1. A first end of the output capacitor Co_1 is coupled to the cathode of the second diode D2_1. A second end of the output capacitor Co_1 is coupled to a second reference voltage (e.g. the ground voltage).

An i^{th} charge pump unit CP_i includes an input capacitor Ci_i, an output capacitor Co_i, a first diode D1_i and a second diode D2_i. For example, the second charge pump unit CP_2 includes an input capacitor Ci_2, an output capacitor Co_2, a first diode D1_2 and a second diode D2_2, and the N^{th} charge pump unit includes an input capacitor Ci_N, an output capacitor Co_N, a first diode D1_N and a second diode D2_N. A first end of the input capacitor Ci_i is coupled to the signal input terminal 101 for receiving the AC input voltage Vin. A cathode of the first diode D1_1 is coupled to a second end of the input capacitor Ci_i. An anode of the first diode D1_i is coupled to an output terminal of a pre-stage charge pump unit (i.e. an output terminal of an (i−1)^{th} charge pump unit CP_(i−1)). An anode of the second diode D2_i is coupled to the second end of the input capacitor Ci_i. A cathode of the second diode D2_i serves as an output terminal of the i^{th} charge pump unit CP_i. A first end of the output capacitor Co_i is coupled to the cathode of the second diode D2_i. A second end of the output capacitor Co_i is coupled to a second reference voltage (e.g. the ground voltage).

For example, in the N^{th} charge pump unit CP_N, a first end of the input capacitor Ci_N is coupled to the signal input terminal 101 for receiving the AC input voltage Vin. A cathode of the first diode D1_N is coupled to a second end of the input capacitor Ci_N. An anode of the first diode D1_N is coupled to an output terminal of a previous charge pump unit CP_(N−1). An anode of the second diode D2_N is coupled to the second end of the input capacitor Ci_N. A first end of the output capacitor Co_N is coupled to the cathode of the second diode D2_N. A second end of the output capacitor Co_N is coupled to the ground. A cathode of the second diode D2_N serves as an output terminal of the N^{th} charge pump unit CP_N. The output terminal of the N^{th} charge pump unit CP_N is coupled to the signal output terminal 102 for outputting a direct current (DC) output voltage Vout.

When the AC input voltage Vin of the signal output terminal 101 is in a positive half-cycle, if the input voltage Vin is greater than a threshold voltage of the diode, the second diodes D2_1-D2_N are turned on, and the first diodes D1_1-D1_N are turned off. Therefore, the input voltage Vin charges the output capacitor Co_1-Co_N. When the AC input voltage Vin of the signal output terminal 101 is in a negative half-cycle, if the input voltage Vin is greater than the threshold voltage of the diode, the second diodes D2_1-D2_N are turned off, and the first diodes D1_1-D1_N are turned on. Therefore, the input voltage Vin charges the input capacitor Ci_1-Ci_N. By repeating the above processes, a voltage of the output terminal of the first charge pump unit CP_{—}1 (i.e. the cathode of the second diode D2_1) is close to 2Vin, a voltage of the output terminal of the second charge pump unit CP_2 (i.e. the cathode of the second diode D2_2) is close to 3Vin, and a voltage of the output terminal of the N^{th} charge pump unit CP_N (i.e. the cathode of the second diode D2_N) is close to (N+1)Vin.

Referring to FIG. 1, the multistage charge pump is mainly composed of diodes (or transistors) and capacitors. The multistage charge pump converts the AC input voltage Vin into the DC output voltage Vout, and has a voltage boosting (voltage gain) function. The charge pump designed in multistage and having the voltage boosting function is suitable for rectifying a low power signal. When an amplitude of the AC input voltage Vin of the charge pump unit is greater than the threshold voltage of the transistor/diode, the AC input voltage Vin turns on a part of the transistors/diodes in the charge pump unit and charges the corresponding capacitor in the positive half-cycle and the negative half-cycle thereof, so as to rectify the AC input voltage Vin into the DC output voltage Vout. According to the multistage design of the charge pump units, the voltage boosting effect is achieved, i.e. a voltage of the output terminal of the N^{th} charge pump unit CP_N is (N+1)Vin.

However, the voltage of the output terminal of the N^{th} charge pump unit CP_N is actually smaller than (N+1)Vin. Namely, a difference ΔV exists between the actual output voltage Vout and the ideal output voltage (N+1)Vin. The difference ΔV is caused by accumulating the threshold voltages of the diodes D1_1-D1_N and/or D2_1-D2_N. If the input voltage Vin is a large voltage, the difference ΔV caused by the threshold voltages of the diodes is tolerable. When the input voltage Vin of the rectifier 100 is a weak signal of a microwatt level, the amplitude of the input voltage Vin is very tiny, and the design of the charge pump rectifier is bottlenecked and challenged. In this case, the difference ΔV caused by the threshold voltages of the diodes D1_1-D1_N and/or D2_1-D2_N cannot be neglected since the difference ΔV caused by the threshold voltages can greatly decrease the DC output voltage Vout. In a current complementary metal-oxide semiconductor (CMOS) process, a threshold voltage of an N-channel metal oxide semiconductor (NMOS) transistor (diode) is about 0.6V. A voltage peak of the micro-power input voltage Vin is probably far lower than the threshold voltage of the NMOS transistor (diode), so that the transistor/diode cannot be turned on, and the output voltage Vout of the rectifier 100 is 0.

In the present embodiment, the rectifier 100 for the low-power or micro-power signal can use native NMOS transistors to implement the diodes D1_1-D1_N and/or D2_1-D2_N. A theoretical threshold voltage of the native NMOS transistor is about 0.05V, so that the performance of the rectifier 100 using the native NMOS transistors in the low power application is greatly improved. However, the threshold voltage of the native NMOS transistor can be amplified to about 0.2V-0.3V due to influences of various factors such as process and parasitic effect, etc., if the input voltage Vin is the micro-power application, a rectifying efficiency thereof is extremely low, which is lower than 10%. Namely, in most part of time of a signal cycle of the input voltage Vin, the voltage amplitude of the input voltage Vin is probably lower than the threshold voltage of the transistor/diode. Therefore, in most part of time of the signal cycle of the input voltage Vin, the diodes D1_1-D1_N and/or D2_1-D2_N cannot be turned on, which leads to a poor AC-DC conversion efficiency of the rectifier 100.

FIG. 2 is a circuit schematic diagram of a micro-power rectifier 200 according to an embodiment of the disclosure. The micro-power rectifier 200 includes a signal input terminal 201, a signal output terminal 202 and N charge pump units CP_1, CP_2, . . . , CP_N. The diodes D1_1-D1_N and/or D2_1-D2_N shown in FIG. 2 can be Schottky barrier diodes or other types of diode. Alternatively, the diodes D1_1-D1_N and/or D2_1-D2_N can be implemented by P-channel metal oxide semiconductor (PMOS) transistors or NMOS transistors. The situation of using the transistors to implement the diodes is described in detail later.

Related descriptions of FIG. 1 can be referred for the embodiment of FIG. 2. Similar to the embodiment of FIG. 1, the first reference voltage Vref_0 of the anode of the first diode D1_1 of the first charge pump unit CP_1 is the ground voltage (i.e. 0V). In other embodiment, the first reference voltage Vref_0 is greater than 0V. Different to the embodiment of FIG. 1, in the embodiment of FIG. 2, the output capacitors Co_1-Co_N are respectively applied with a plurality of second reference voltages Vref_1, Vref_2, . . . , Vref_N. A level of at least one of the first reference voltage Vref_0 and the second reference voltages Vref_1, Vref_2, . . . , Vref_N is a bias voltage Vcbias greater than 0V, and the others are the ground voltage.

In some embodiments, the levels of the second reference voltages Vref_1-Vref_N are different. In some other embodiments, a part of the levels of the second reference voltages Vref_1-Vref_N are the same, and others are different. In some other embodiments, the second reference voltages Vref_1-Vref_N are all the same bias voltage Vcbias, and a level of the bias voltage Vcbias can be determined according to an actual design requirement.

An operation principle of the rectifier 200 is the same to the rectifier 100 of FIG. 1. It is assumed that the second reference voltages Vref1-Vref_N shown in FIG. 2 are all DC bias voltages Vcbias. After the rectifier 200 is powered, the bias voltage Vcbias is increased from 0V to a predetermined DC voltage level. Therefore, the bias voltage Vcbias that is greater than 0V increases an input DC voltage level of the charge pump unit of each stage. For example, the bias voltage Vcbias that is greater than 0V increases the input voltage level (i.e. a voltage on the anode of the diode D1_2) of the charge pump unit CP_2. Therefore, a conducting time of the diode is increased within the signal cycle to ensure a longer charging time of the capacitor of the rectifier 200, so as to improve the AC-DC conversion efficiency. Meanwhile, since the second end of the output capacitor Co_N is connected to the bias voltage Vcbias, the bias voltage Vcbias increases a voltage level of the output terminal 202, so that the output DC voltage of the rectifier 200 is more suitable for a bias or charging application of a post circuit.

In another embodiment, the levels of the second reference voltages Vref_1-Vref_N are different, and the second reference voltages Vref_1-Vref_N are all greater than 0V. After the rectifier 200 is powered, the second reference voltages Vref_1-Vref_N are respectively increased from 0V to differed predetermined DC voltage levels. Therefore, the second reference voltages Vref_1-Vref_N that are greater than 0V increase the input DC voltage level of the charge pump unit of each stage, so as to improve the AC-DC conversion efficiency.

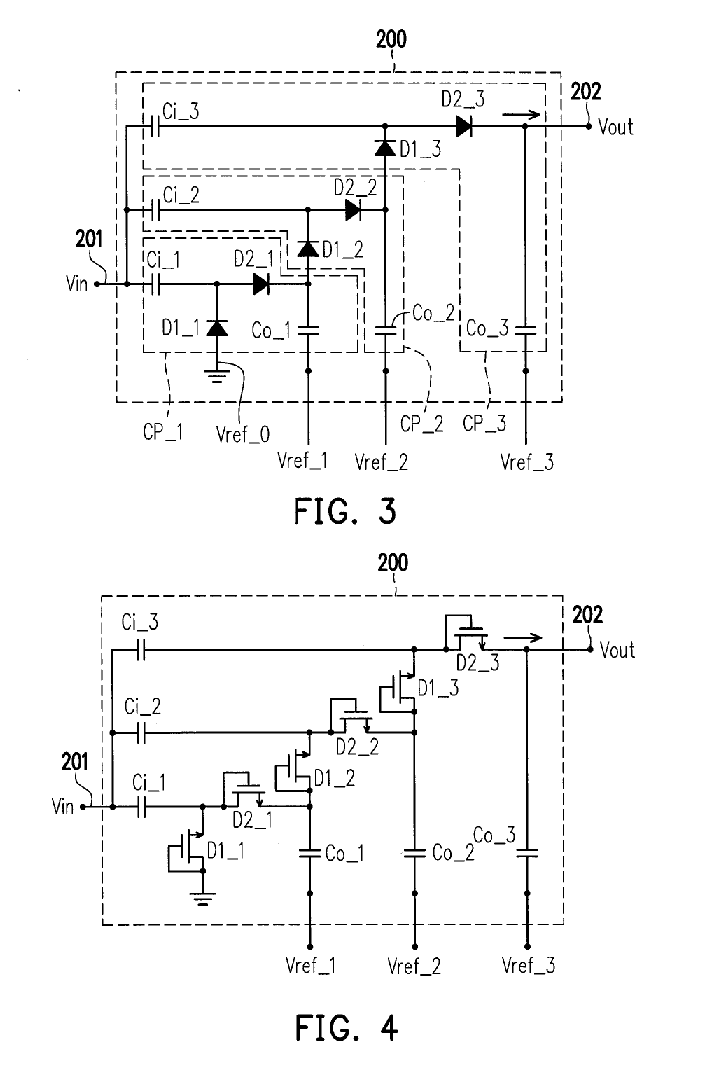

FIG. 3 is an exemplary circuit schematic diagram of the rectifier 200 of FIG. 2 in case of N=3. Related descriptions of the embodiment of FIG. 2 can be referred for the embodiment of FIG. 3. FIG. 3 illustrates a 3-stage charge pump rectifier. The rectifier 200 of FIG. 3 includes three charge pump units CP_1, CP_2 and CP_3. The charge pump unit CP_1 of the first stage includes a capacitor Ci_1, a capacitor Co_1, a diode D1_1 and a diode D2_1. The capacitor Ci_1 is connected between the input terminal 201 and a cathode of the diode D11, and an anode of the diode D1_1 is coupled to the ground. An anode of the diode D2_1 is connected to the cathode of the diode D1_1, and a cathode of the diode D2_1 is connected to a first end of the capacitor Co_1. A second end of the capacitor Co_1 is connected to the second reference voltage Vref_1.

The charge pump unit CP_2 of the second stage includes a capacitor Ci_2, a capacitor Co_2, a diode D12 and a diode D2_2. The capacitor Ci_2 is connected to the input terminal 201 and a cathode of the diode D1_2, and an anode of the diode D12 is coupled to the cathode of the diode D21. An anode of the diode D22 is connected to the cathode of the diode D1_2, and a cathode of the diode D2_2 is connected to a first end of the capacitor Co_2. A second end of the capacitor Co_2 is connected to the second reference voltage Vref_2.

The charge pump unit CP_3 of the third stage includes a capacitor Ci_3, a capacitor Co_3, a diode D1_3 and a diode D2_3. The capacitor Ci_3 is connected to the input terminal 201 and a cathode of the diode D1_3, and an anode of the diode D1_3 is coupled to the cathode of the diode D2_2. An anode of the diode D2_3 is connected to the cathode of the diode D1_3, and a cathode of the diode D2_3 is connected to a first end of the capacitor Co_3. A second end of the capacitor Co_3 is connected to the second reference voltage Vref_3.

The diodes D1_1-D1_3 and the diodes D2_1-D2_3 can be implemented by NMOS transistors. For example, FIG. 4 is an exemplary circuit schematic diagram of the rectifier 200 of FIG. 3. The embodiment of FIG. 4 can refer to related descriptions of the embodiments of FIG. 2 and FIG. 3. Different to the embodiment of FIG. 3, the embodiment of FIG. 4 uses the NMOS transistors to implement the diodes D1_1-D1_3 and the diodes D2_1-D2_3. A gate and a drain of the NMOS transistor are connected and are equivalent to an anode of a diode, and a source of the NMOS transistor is equivalent to a cathode of the diode.

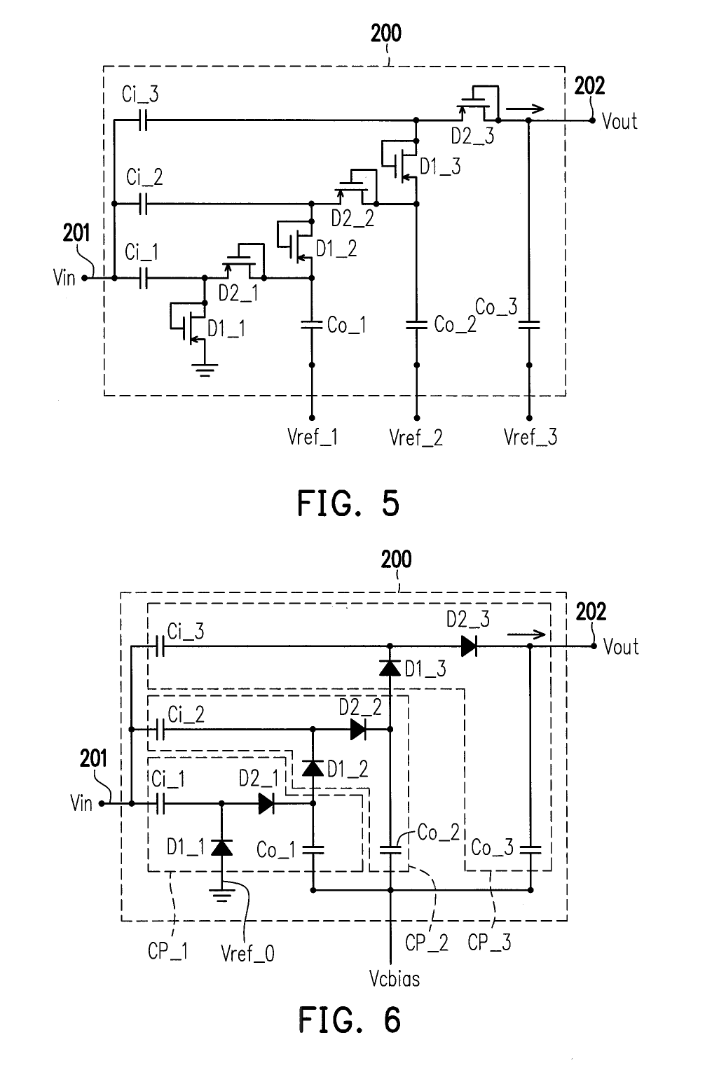

The diodes D1_1-D1_3 and the diodes D2_1-D2_3 can be implemented by PMOS transistors. For example, FIG. 5 is another exemplary circuit schematic diagram of the rectifier 200 of FIG. 3. The embodiment of FIG. 5 can refer to related descriptions of the embodiments of FIG. 2 and FIG. 3. Different to the embodiment of FIG. 3, the embodiment of FIG. 5 uses the PMOS transistors to implement the diodes D1_1-D1_3 and the diodes D2_1-D2_3. A gate and a drain of the PMOS transistor are connected and are equivalent to a cathode of a diode, and a source of the PMOS transistor is equivalent to an anode of the diode.

According to an actual design requirement, the capacitors Co_1-Co_3 of the charge pump units of the three stages can be supplied with different bias voltages Vref_1-Vref_3. By determining the respective voltage levels of the bias voltages Vref_1-Vref_3, the rectifying efficiency of the rectifier 200 can be optimised to improve the AC-DC conversion efficiency of the charge pump unit of each stage.

For example, the bias voltages Vref_1-Vref_3 are all the bias voltage Vcbias greater than 0V. FIG. 6 is another exemplary circuit schematic diagram of the rectifier 200 of FIG. 3. The embodiment of FIG. 6 can refer to related descriptions of the embodiments of FIG. 2 and FIG. 3. Different to the embodiment of FIG. 3, in the embodiment of FIG. 6, the capacitors Co_1-Co_3 of the charge pump units of the three stages are supplied with the bias voltage Vcbias greater than 0V. A level of the bias voltage Vcbias can be determined according to an actual design requirement.

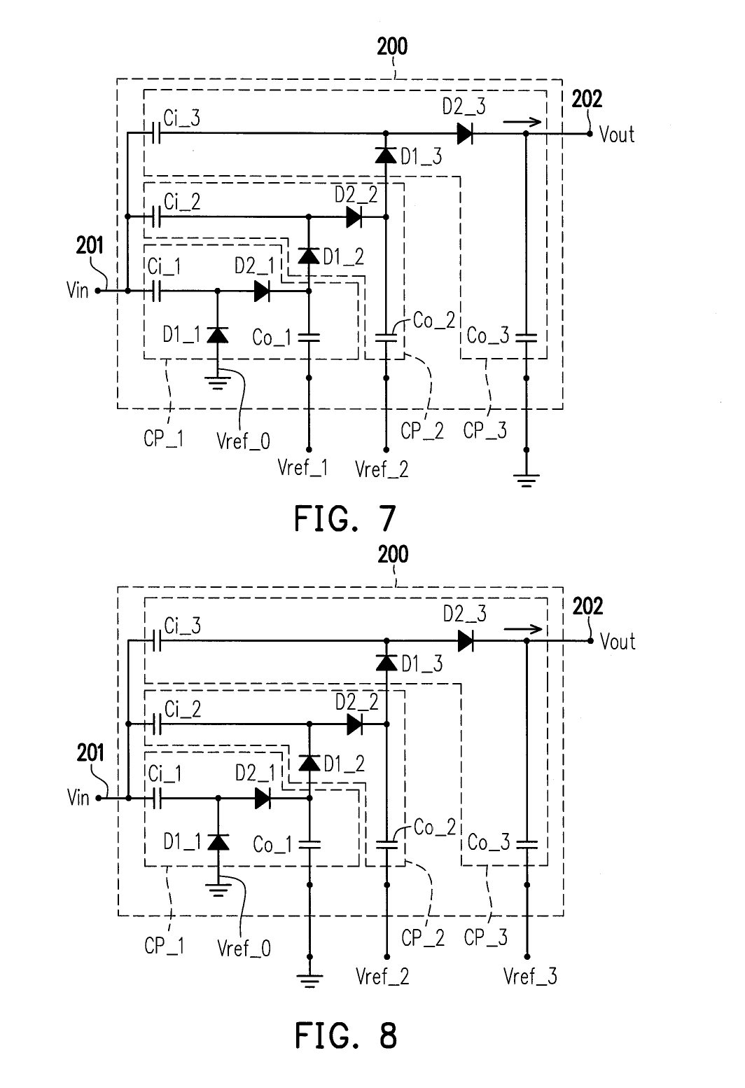

FIG. 7 is another exemplary circuit schematic diagram of the rectifier 200 of FIG. 3. The embodiment of FIG. 7 can refer to related descriptions of the embodiments of FIG. 3. Different to the embodiment of FIG. 3, in the embodiment of FIG. 7, the capacitors Co_1 and Co_2 of the charge pump units CP_1 and CP_2 are supplied with the bias voltages Vref_1 and Vref_2 greater than 0V, and the capacitor Co_3 of the charge pump unit CP_3 is coupled to the ground.

FIG. 8 is another exemplary circuit schematic diagram of the rectifier 200 of FIG. 3. The embodiment of FIG. 8 can refer to related descriptions of the embodiments of FIG. 3. Different to the embodiment of FIG. 3, in the embodiment of FIG. 8, the capacitor Co_1 of the charge pump unit CP_1 is coupled to the ground, and the capacitors Co_2 and Co_3 of the charge pump units CP_2 and CP_3 are supplied with the bias voltages Vref_2 and Vref_3 greater than 0V.

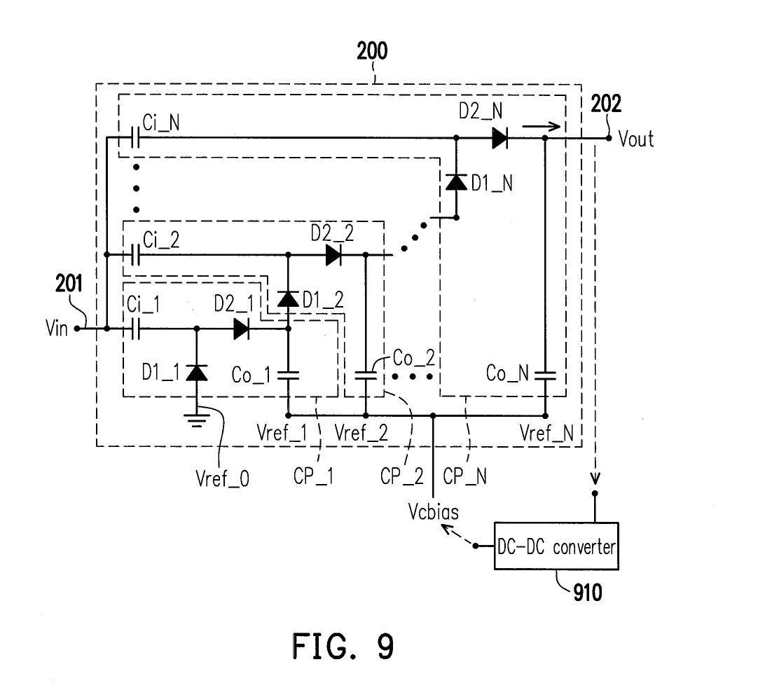

FIG. 9 is a circuit schematic diagram of a micro-power rectifier 200 according to another embodiment of the disclosure. The embodiment of FIG. 9 can refer to related descriptions of the embodiment of FIG. 2. Different to the embodiment of FIG. 2, the micro-power rectifier 200 of FIG. 9 further includes a DC-DC converter 910. An input terminal of the DC-DC converter 910 is coupled to a signal output terminal 202 of the micro-power rectifier 200 for receiving the output voltage Vout. An output terminal of the DC-DC converter 910 is coupled to the charge pump units CP_1-CP_N. The DC-DC converter 910 converts the output voltage Vout of the signal output terminal 202 of the micro-power rectifier 200 into the second reference voltages Vref_1-Vref_N, and provides the second reference voltages Vref_1-Vref_N to the charge pump units CP_1-CP_N. In the present embodiment, the second reference voltages Vref_1-Vref_N are all the bias voltage Vcbias greater than 0V. The bias voltage Vcbias is provided by the DC-DC converter 910. The DC-DC converter 910 regulates the output voltage Vout, and outputs the DC bias voltage Vcbias to the charge pump units CP_1-CP_N.

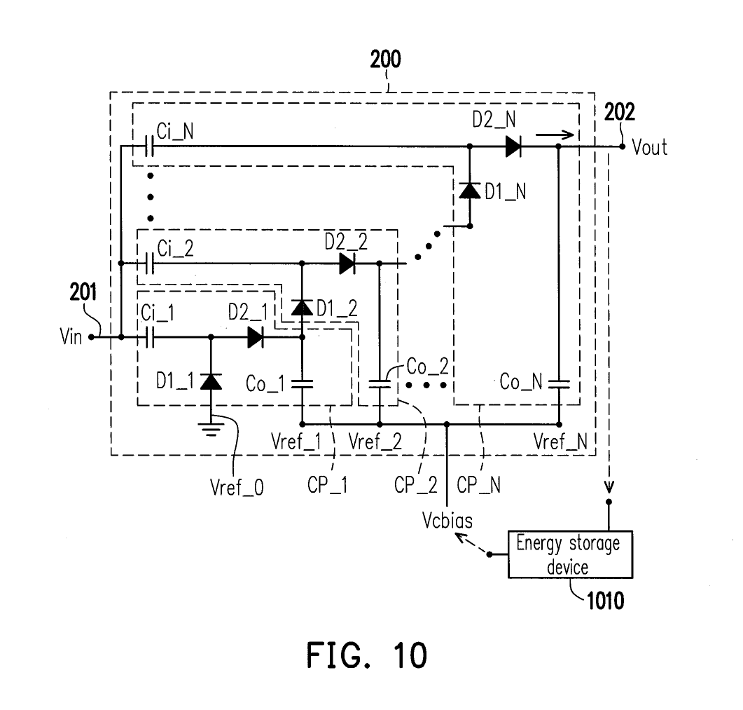

FIG. 10 is a circuit schematic diagram of a micro-power rectifier 200 according to still another embodiment of the disclosure. The embodiment of FIG. 10 can refer to related descriptions of the embodiments of FIG. 2 and FIG. 9. Different to the embodiment of FIG. 2, the micro-power rectifier 200 of FIG. 10 further includes an energy storage device 1010. The energy storage device 1010 can be a rechargeable battery, a capacitor or other energy storage devices. The energy storage device 1010 is coupled between the signal output terminal 201 and the charge pump units CP_1-CP_N of the micro-power rectifier 200. The energy storage device 1010 converts the output voltage Vout of the signal output terminal 202 of the micro-power rectifier 200 into the second reference voltages Vref_1-Vref_N, and provides the second reference voltages Vref_1-Vref_N to the charge pump units CP_1-CP_N. In the present embodiment, the second reference voltages Vref_1-Vref_N are all the bias voltage Vcbias greater than 0V. The bias voltage Vcbias is provided by the energy storage device 1010. The energy storage device 1010 regulates the output voltage Vout, and outputs the DC bias voltage Vcbias to the charge pump units CP_1-CP_N.

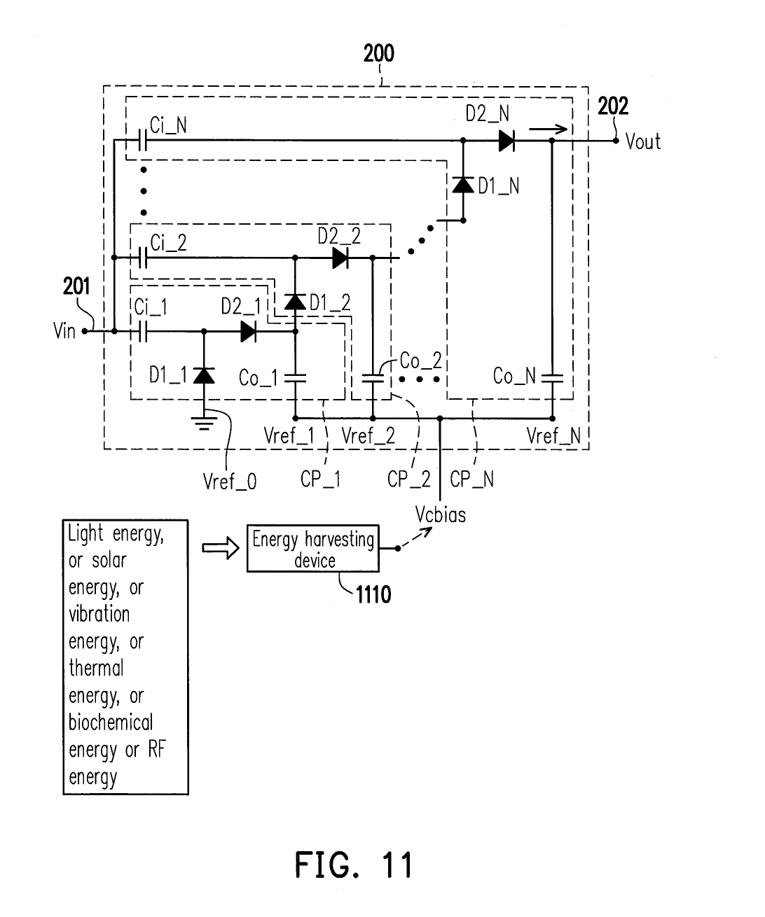

FIG. 11 is a circuit schematic diagram of a micro-power rectifier 200 according to still another embodiment of the disclosure. The embodiment of FIG. 11 can refer to related descriptions of the embodiments of FIG. 2 and FIG. 9. Different to the embodiment of FIG. 2, the micro-power rectifier 200 of FIG. 11 further includes an energy harvesting device 1110. An output terminal of the energy harvesting device 1110 is coupled to the charge pump units CP_1-CP_N. The energy harvesting device 1110 can convert non-electrical energy into electrical energy, and provides the second reference voltages Vref_1-Vref_N to the charge pump units CP_1-CP_N. The non-electrical energy can be light energy, solar energy, vibration energy, thermal energy, biochemical energy or radio frequency energy. In the present embodiment, the energy harvesting device 1110 can provide the bias voltage Vcbias greater than 0V to the charge pump units CP_1-CP_N to serve as the second reference voltages Vref_1-Vref_N.

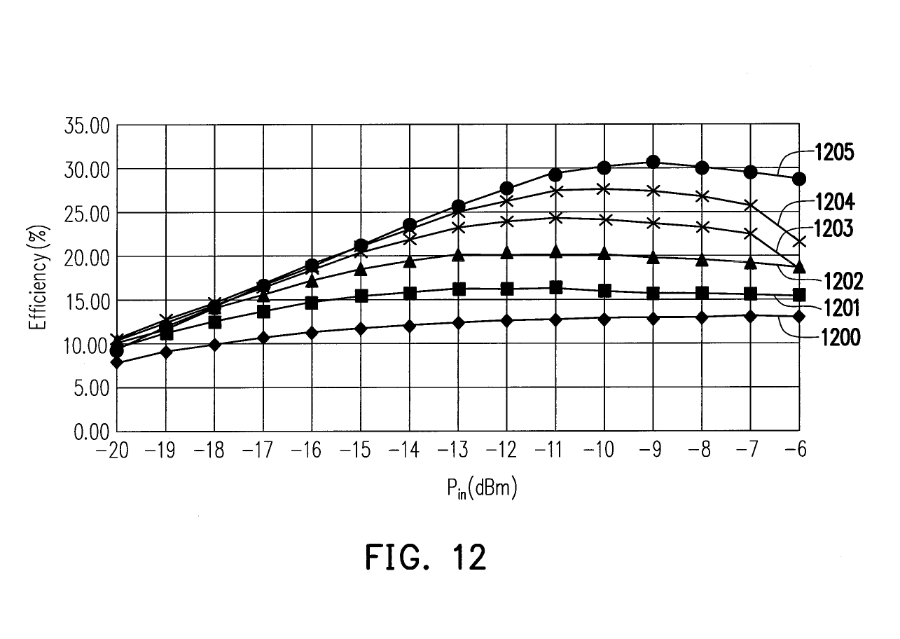

The rectifier 200 can be implemented in a CMOS process. Taking 7-stage (i.e. N=7) charge pump units as an example, under an operation condition of a 0.9 GHz frequency band, a size thereof is about 350 μm×300 μm. It is assumed that a frequency of an RF input voltage Vin is 0.9 GHz, and the second reference voltages Vref_1-Vref_7 of the charge pump units CP_1-CP_7 are all the same bias voltage Vcbias. FIG. 12 is a measurement diagram of AC-DC conversion efficiency of the rectifier 200 with the CMOS process and 7-stage charge pump units. A measurement range of an input power Pin of the 0.9 GHz RF input voltage Vin is from −20 dBm to −6 dBm, and a modulation range of the bias voltage Vcbias is from 0.1V to 0.5V. In FIG. 12, a vertical axis represents the conversion efficiency of the rectifier 200, and a horizontal axis represents the input power Pin of the 0.9 GHz RF input voltage Vin.

A curve 1200 represents conversion efficiency of the rectifier 200 when the bias voltage Vcbias is 0V. A curve 1201 represents conversion efficiency of the rectifier 200 when the bias voltage Vcbias is 0.1V. A curve 1202 represents conversion efficiency of the rectifier 200 when the bias voltage Vcbias is 0.2V. A curve 1203 represents conversion efficiency of the rectifier 200 when the bias voltage Vcbias is 0.3V. A curve 1204 represents conversion efficiency of the rectifier 200 when the bias voltage Vcbias is 0.4V. A curve 1205 represents conversion efficiency of the rectifier 200 when the bias voltage Vcbias is 0.5V. According to FIG. 12, it is discovered that the bias voltage Vcbias can effectively improve the AC-DC conversion efficiency of the rectifier 200 in case of different input power Pin. The greater the bias voltage Vcbias is, the greater the improved efficiency is. Taking the input power Pin of −15 dBm as an example, when the bias voltage Vcbias is 0V, the rectifying efficiency is only 11.7%, when the bias voltage Vcbias is 0.1V, the rectifying efficiency is improved to 15.43%, and when the bias voltage Vcbias is 0.3V, the rectifying efficiency is further improved to 20.27%.

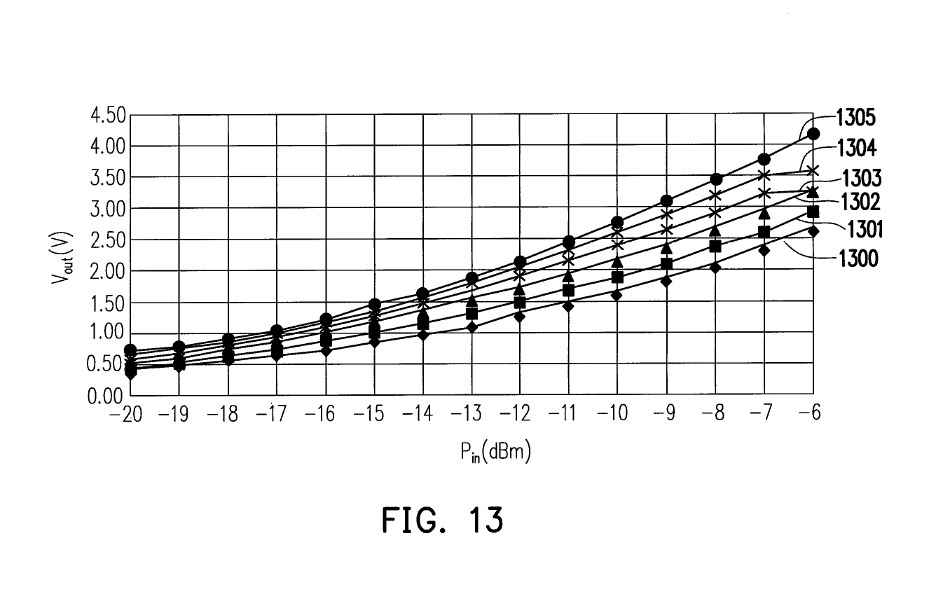

FIG. 13 is a measurement diagram of the DC output voltage Vout of the rectifier 200 with the CMOS process and 7-stage charge pump units. In FIG. 13, a vertical axis represents the DC output voltage Vout of the rectifier 200, and a horizontal axis represents the input power Pin of the RF input voltage Vin. A measurement range of the input power Pin of the 0.9 GHz RF input voltage Vin is from −20 dBm to −6 dBm, and a modulation range of the bias voltage Vcbias is from 0.1V to 0.5V.

A curve 1300 represents the output voltage Vout of the rectifier 200 when the bias voltage Vcbias is 0V. A curve 1301 represents the output voltage Vout of the rectifier 200 when the bias voltage Vcbias is 0.1V. A curve 1302 represents the output voltage Vout of the rectifier 200 when the bias voltage Vcbias is 0.2V. A curve 1303 represents the output voltage Vout of the rectifier 200 when the bias voltage Vcbias is 0.3V. A curve 1304 represents the output voltage Vout of the rectifier 200 when the bias voltage Vcbias is 0.4V. A curve 1305 represents the output voltage Vout of the rectifier 200 when the bias voltage Vcbias is 0.5V. According to FIG. 13, it is discovered that the bias voltage Vcbias can effectively increase the DC output voltage Vout of the rectifier 200 in case of different input power Pin. The greater the bias voltage Vcbias is, the greater the increased output voltage Vout is. Taking the input power Pin of −15 dBm as an example, when the bias voltage Vcbias is 0V, the output voltage Vout is only 0.89V, when the bias voltage Vcbias is 0.1V, the rectifying efficiency is increased to 1.07V, and when the bias voltage Vcbias is 0.3V, the output voltage Vout is further increased to 1.33V.

A method of the micro-power rectifier 200 of the aforementioned embodiments is described below. The method includes following steps. The signal input terminal 201 receives the input voltage Vin. A first reference voltage Vref_0 is provided to the anode of the first diode D1_1 of the first charge pump unit CP_1. A plurality of second reference voltages Vref_1-Vref_N are provided to the second ends of the output capacitors Co_1-Co_N of the charge pump units CP_1-CP_N. At least one of the first reference voltage Vref_0 and the second reference voltages Vref_1-Vref_N is increased to be greater than 0V.

In summary, the AC-DC rectifier 200 suitable for a micro-power application is composed of multistage charge pump units, where one or a plurality of the output capacitors in the multistage charge pump units are coupled to the bias voltage Vcbias greater than 0V, so that a level of the output voltage Vout of the rectifier 200 is increased, and the AC-DC conversion efficiency of the rectifier 200 in case of a micro-power input is improved, such that the DC energy converted by the rectifier 200 can be effectively used. Since the rectifier 200 does not require a complicated control circuit and a switch circuit, not only complexity and cost of the whole circuit are reduced, extra energy loss of the control circuit is avoided. On the other hand, the rectifier 200 is unnecessary to pre-store the output DC energy, and can constantly provide a high voltage output, so that an application range thereof is wide.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A micro-power rectifier, comprising:
a signal input terminal;
a signal output terminal; and
a plurality of charge pump units, wherein each of the charge pump units respectively comprises:
an input capacitor, having a first end coupled to the signal input terminal;
a first diode, having a cathode coupled to a second end of the input capacitor, wherein an anode of the first diode coupled to a first reference voltage if the first diode belongs in the first charge pump unit (CP_1), and the anode of the first diode coupled to an output terminal of a pre-stage charge pump unit of the charge pump units if the first diode belongs in the other charge pump unit (CP_i), wherein i is an integer greater than 1;
a second diode, having an anode coupled to the second end of the input capacitor, and a cathode serving as an output terminal of the charge pump unit; and
an output capacitor, having a first end coupled to the cathode of the second diode, and a second end coupled to a second reference voltage, wherein at least one of the first reference voltage and the second reference voltages is greater than 0V.

2. The micro-power rectifier as claimed in claim 1, wherein a level of at least one of the reference voltages is a bias voltage greater than 0V, and the others are a ground voltage.

3. The micro-power rectifier as claimed in claim 1, wherein the first reference voltage is a ground voltage, and the second reference voltages are all a bias voltage greater than 0V.

4. The micro-power rectifier as claimed in claim 1, wherein levels of the reference voltages are different.

5. The micro-power rectifier as claimed in claim 1, further comprising:
a direct current (DC)-DC converter, having an input terminal coupled to the signal output terminal of the micro-power rectifier, and an output terminal coupled to the charge pump units for providing the reference voltages.

6. The micro-power rectifier as claimed in claim 1, further comprising:
an energy storage device, coupled between the signal output terminal of the micro-power rectifier and the charge pump units for providing the reference voltages.

7. The micro-power rectifier as claimed in claim 6, wherein the energy storage device comprises a rechargeable battery or a capacitor.

8. The micro-power rectifier as claimed in claim 1, further comprising:
an energy harvesting device, having an output terminal coupled to the charge pump units, wherein the energy harvesting device converts non-electrical energy into electrical energy, and provides the reference voltages to the charge pump units.

9. The micro-power rectifier as claimed in claim 8, wherein the non-electrical energy is light energy, solar energy, vibration energy, thermal energy, biochemical energy or radio frequency energy.

10. The micro-power rectifier as claimed in claim 1, wherein the first diodes and the second diodes are Schottky barrier diodes, P-channel metal oxide semiconductor transistors or N-channel metal oxide semiconductor transistors.

11. A method of a micro-power rectifier, wherein the micro-power rectifier is as claimed in claim 1, the method comprising:
receiving an input voltage by the signal input terminal;
providing a first reference voltage to the anode of the first diode of the first charge pump unit (CP_1);
providing a plurality of second reference voltages to the second ends of the output capacitors of the charge pump units; and
increasing at least one of the first reference voltage and the second reference voltages to be greater than 0V.

12. The method of the micro-power rectifier as claimed in claim 11, wherein a level of at least one of the reference voltages is a bias voltage greater than 0V, and the others are a ground voltage.

13. The method of the micro-power rectifier as claimed in claim 11, wherein the first reference voltage is a ground voltage, and the second reference voltages are all a bias voltage greater than 0V.

14. The method of the micro-power rectifier as claimed in claim 11, wherein levels of the reference voltages are different.

15. The method of the micro-power rectifier as claimed in claim 11, further comprising:
using a DC-DC converter to convert an output voltage of the signal output terminal of the micro-power rectifier into the reference voltages for providing to the charge pump units.

16. The method of the micro-power rectifier as claimed in claim 11, further comprising:
using an energy storage device to convert an output voltage of the signal output terminal of the micro-power rectifier into the reference voltages for providing to the charge pump units.

17. The method of the micro-power rectifier as claimed in claim 16, wherein the energy storage device comprises a rechargeable battery or a capacitor.

18. The method of the micro-power rectifier as claimed in claim 11, further comprising:
using an energy harvesting device to convert non-electrical energy into electrical energy, and providing the reference voltages to the charge pump units.

19. The method of the micro-power rectifier as claimed in claim 18, wherein the non-electrical energy is light energy, solar energy, vibration energy, thermal energy, biochemical energy or radio frequency energy.
